(19) United States
(12) Patent Application Publication
(10) Pub. No.: US 2013/0326330 A1
(43) Pub. Date: Dec. 5, 2013

(54) INTEGRATING COLLABORATIVELY PROPOSED CHANGES AND PUBLISHING

(71) Applicants: Jeff Harris, New York, NY (US); Scott M. Johnston, Darien, CT (US); Ian Gunn, San Francisco, CA (US)

(72) Inventors: Jeff Harris, New York, NY (US); Scott M. Johnston, Darien, CT (US); Ian Gunn, San Francisco, CA (US)

(73) Assignee: Google Inc., Mountain View, CA (US)

(21) Appl. No.: 13/486,561

(22) Filed: Jun. 1, 2012

(51) Int. Cl. G06F 17/00

(52) U.S. Cl. 715/234

(57) ABSTRACT

Systems and methods are disclosed herein for integrating collaboratively proposed changes and publishing an electronic document among multiple users, each user having a different level of access and rights to the document. A first suggested edit to the electronic document is received from a reviewer, and a markup version of the electronic document is updated to reflect the first suggested edit. An acceptance or a rejection of the first suggested edit is received from an editor. In response to receiving an acceptance of the first suggested edit, the first suggested edit is converted to an accepted edit, yielding a second updated markup version. The clean version of the electronic document is updated with the accepted edit, and the updated clean version is published.

### FIELD OF THE INVENTION

In general, this disclosure relates to electronic documents, in particular, to systems and methods for integrating collaboratively proposed changes and publishing in an electronic document.

### BACKGROUND

During development of an electronic document, it is often desirable to have multiple reviewers propose changes to and comment on a draft of the electronic document. For example, an author may create an initial draft of an electronic document and send a copy of the electronic document to multiple reviewers for comments. Each reviewer may independently propose changes or make comments in the electronic document and return a revised version of the electronic document back to the author. Since each of the reviewers may create a unique version of the electronic document, each of which may include conflicting changes, the original author will need to resolve the conflicting changes and re-send updated copies of the electronic document to the reviewers. These steps will need to be repeated until the author and all of the reviewers are satisfied with a version of the electronic document.

### SUMMARY

Systems and methods disclosed herein provide integration of collaboratively proposed changes and publication of an electronic document. One aspect relates to systems and methods for integrating collaboratively proposed changes and publishing an electronic document. A first suggested edit to the electronic document is received from a reviewer, and a markup version of the electronic document is updated to reflect the first suggested edit. An acceptance or a rejection of the first suggested edit is received from an editor. In response to receiving an acceptance of the first suggested edit, the first suggested edit is converted to an accepted edit, yielding a second updated markup version. The clean version of the electronic document is updated with the accepted edit, and the updated clean version is published.

### BRIEF DESCRIPTION OF THE DRAWINGS

The above and other features of the present disclosure, including its nature and its various advantages, will be more apparent upon consideration of the following detailed description, taken in conjunction with the accompanying drawings in which:

FIG. 1A is a block diagram of a computerized system for integrating collaboratively proposed changes and publishing an electronic document, according to an illustrative embodiment.

FIG. 1B is an example data structure stored on electronic database that includes a document access control list, according to an illustrative embodiment.

FIG. 1C are two exemplary data structures stored on an electronic database that include metadata corresponding to suggested edits and comments, according to an illustrative embodiment.

FIGS. 2A-2F are diagrams of exemplary displays of a user interface for an editor interacting with a document, according to an illustrative embodiment.

FIG. 3 is a flowchart of a method used by the review manager to manage updates to the markup and clean versions of the document, according to an illustrative embodiment.

FIG. 4 is a flowchart of a method used by the review manager to manage updates to the markup and clean versions of the document, according to an illustrative embodiment.

FIG. 5 is a flowchart of a method used by the review manager to store and display metadata corresponding to edits received from users of the document, according to an illustrative embodiment.

FIG. 6 is a diagram of an exemplary display of a reviewer interface for a reviewer interacting with the document, according to an illustrative embodiment.

FIG. 7 is a diagram of an exemplary display of a viewer interface for a viewer interacting with the document, according to an illustrative embodiment.

FIG. 8 is a flowchart of a method used by the review manager to handle a request for a change in user type from a user, according to an illustrative embodiment.

FIG. 9 is a flowchart of a method used by the review manager to handle a request to open a document from a user, according to an illustrative embodiment.

FIG. 10 is a block diagram of a computing device for performing any of the processes described herein.

### DETAILED DESCRIPTION

To provide an overall understanding of the disclosure, certain illustrative embodiments will now be described, including a system for integrating collaboratively proposed changes and publishing. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof.

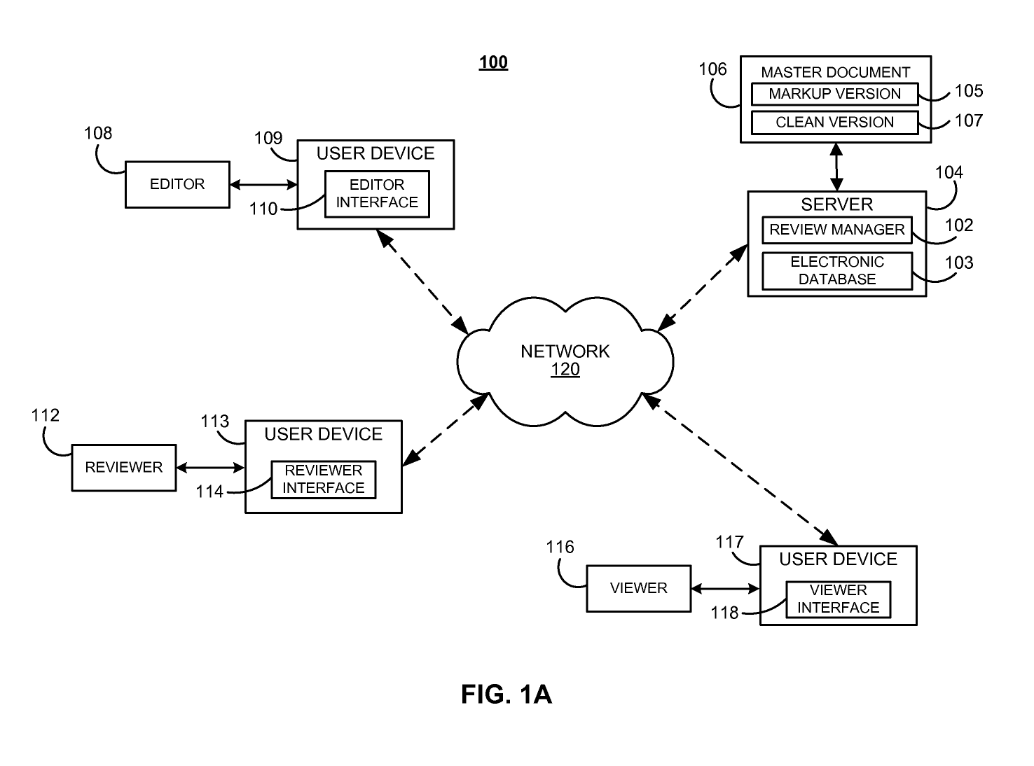

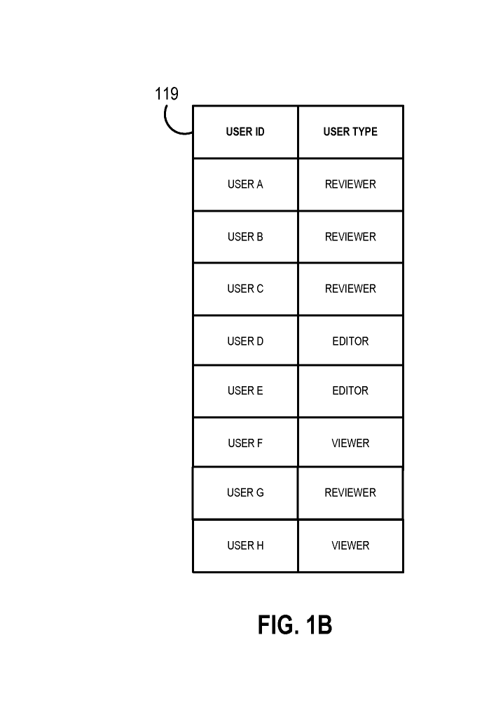

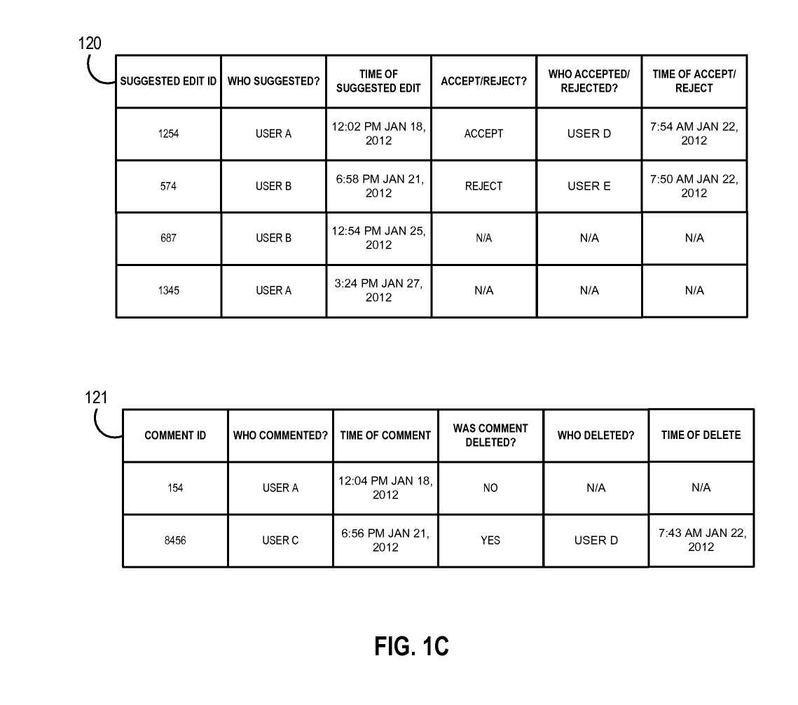

FIGS. 1A-1C are diagrams of a network and database structures that may be used to implement the systems and methods disclosed herein. FIG. 1A is a block diagram of a computerized system 100 for integrating collaboratively proposed changes and publishing an electronic document, according to an illustrative embodiment. System 100 includes a server 104 and three user devices 109, 113, and 117 connected over a network 120. The server 104 includes a review manager 102, which manages updates to various versions of a master document 106.

The review manager 102 is configured to transmit and receive data over the network 120 in communication with user devices 109, 113, and 117. In particular, the review manager 102 receives data indicative of changes that a user at a user device wishes to suggest or create to the master document 106. Depending on the user type, which sets the access permissions for the user to access the master document 106, the review manager 102 then creates these changes in a markup version 105 and/or a clean version 107 of the master document 106.

The review manager 102 may include a processor and a memory unit. The memory unit stores computer executable instructions, which are executed by the processor. The computer executable instructions include instructions for receiving data over the network 120, determining a user type for a given user, making changes to the markup version 105 and/or the clean version 107 of the master document 106, and publishing various versions of the document 106 to various users. As depicted in FIG. 1A, the master document 106 is stored on a separate device from the server 104, but the master document 106 may also be stored in the server's electronic database 103 or even in the memory unit included within the review manager 102. In addition, any data described herein as being stored on the electronic database 103 may instead or additionally be stored in the review manager's memory unit or on a separate memory unit external to the server 104.

Users at user devices 109, 113, and 117 simultaneously interact with the master document 106 over interfaces 110, 114, and 118, respectively. Each user at a user device has a user type (editor 108 for user device 109, reviewer 112 for user device 113, and viewer 116 for user device 117), defining a level of authority for access to and editing capabilities of certain versions of the master document.

Each user device 109, 113, and 117 may include a device such as a personal computer, a lap top computer, a tablet, a smart phone, a personal digital assistant, or any other suitable type of computer of communication device. Users at the user devices access and receive information from the server 104 over the network 120. The user devices 109, 113, and 117 may include typical components, for example, an input device, and output device, and a communication interface (e.g., editor interface 110, reviewer interface 114, or viewer interface 118). A user may authenticate with the server 104 by inputting a user name and password (or providing other identification information) via a user interface, such that the same user device may be used by different users at different times.

Users interact with the server 104 such that the users, in conjunction with the server 104, execute an online document by collaboratively proposing changes to the document 106. Although illustrated as a single device in FIG. 1A, the server 104 may be implemented as, for example, a single computing device or as multiple distributed computing devices. The interaction of users with the server 104 is through user interfaces 110, 114, and 118, which may include web browsers. For example, the document may be viewed with an application that displays the document within a web browser. In this arrangement, users do not need to install software locally to their user devices to view and make changes to the document. When browsers or user interfaces are discussed herein, these terms are intended to refer to any program that allows a user to browse documents, regardless of whether the browser program is a standalone program or an embedded program, such as a browser program included as part of an operating system. The logic described herein can be implemented in hardware, software, firmware, or a combination thereof.

In an example, the document 106 is a text document. One of skill in the art will understand that the features and concepts described herein may be applied in any type of collaborative document application, including, for example, spreadsheet applications, presentation applications, drawing applications, and others.

One type of document user is reviewer 112, who has certain authority and access the document. Typically a reviewer may view and make suggested edits and comments on both markup and clean versions of the document. To do this, the reviewer 112 views a version of the document on the reviewer interface 114 and makes a change to the document. Data indicative of the change is sent over the network 120 to the server 104, where the review manager 102 receives the data and updates the markup version 105 of the document with the change. When the change is a suggested edit to the document, the suggested edit is saved into the markup version 105 of the document in a format that is indicative of the suggested edit (e.g., the edit is saved in a markup or redline mode). When the change is a comment on the document, the comment is saved into the markup version 105, for example, on a side bar of the document.

Another user type is an editor 108, who has a greater level of authority for the document than the reviewer 112. The editor 108 can accept or reject any suggested edits made by the reviewer 112, and further can delete any comments made by the reviewer 112. Access and authority may vary and be customized for a document allowing different access and use capabilities for different users. When the markup version is updated at the editor interface 110, the editor 108 is prompted to either accept or reject a suggested edit. When a suggested edit is accepted by the editor 108, the review manager 102 converts the suggested edit into an accepted edit and updates the markup version 105 of the document with the accepted edit. In addition, the review manager 102 updates the clean version 107 of the document with the accepted edit. If the editor 108 rejects a suggested edit, the review manager 102 removes the suggested edit from the markup version 105 of the document and the suggested edit is not incorporated into the clean version 107 of the document. Similarly, when the editor 108 deletes a comment in the document, the review manager 102 removes the deleted comment from the markup version of the document 105. Comments are generally not visible in the clean version 107 of the document.

In addition to accepting or rejecting changes made by the reviewer 112, the editor 108 also has access to make direct changes to the document by directly editing or making comments on the document 106. The review manager 102 treats edits made by the editor 108 as accepted edits, such that both markup 105 and clean versions 107 of the document are updated with any edits made by the editor 108. Alternatively, the editor 108 may wish to make a suggested edit in order to get input from the reviewer 112 regarding the suggested edit. In this case, the editor 108 may mark an edit as “suggested” or may set the user device 109 to operate in “suggestion mode,” such that the suggested edit appears in the markup version 105 of the document to the reviewer 112. Then, the reviewer 112 may modify the suggested edit or comment on the suggested edit, and the editor 108 may then decide whether to accept or reject the suggested edit.

The updates to the markup version 105 and clean version 107 of the document are performed nearly in real-time. This means that when the reviewer 112 and the editor 108 are simultaneously viewing and accessing the document, the reviewer 112 receives feedback regarding a suggested edit almost immediately after the editor 108 sends the feedback. System 100 is especially advantageous for the case when the reviewer 112's suggested edit may affect additional suggested edits made by the reviewer 112. For example, it is helpful for the reviewer 112 to receive early feedback from an editor 108 regarding a suggested edit because the feedback may influence future suggested edits.

When the interfaces 110, 114, and 118 include web browsers, different versions of the document (for example, a markup version 105 and a clean version 107, or various historical versions of the document, such as those including a selected group of the suggested and/or accepted edits) may be published to different URLs. The editor 108 may select which versions of the master document 106 are published to which URL, and may further select to publish a version of the document in a particular format, such as in browser format, html format, or any other suitable format for publishing an electronic document.

The reviewer 112 and the editor 108 may view who else is currently viewing the document. When more than one user views the document at a time, the users may communicate with each other over an instant messaging application.

Another user type is a viewer 116, who has a lower level of authority than the reviewer 112. The viewer 116 may only view the clean version 107 of the document. The clean version 107 may be viewed at any iteration in the drafting process and will include any previously suggested edits made by the reviewer 112 that were accepted by the editor 108 and also any edits directly made by the editor 108. In contrast to the reviewer 112, the viewer 116 generally may not suggest edits on the document.

In some embodiments, the viewer 116 may make comments on the document in the same way that the reviewer 112 and the editor 108 make comments. In particular, the viewer 116 may access a third version of the document that includes the clean version with comments from the markup version. In this case, the viewer 116 has access to comments made by other users and may introduce additional comments. Alternatively, the viewer 116 may only have access to the clean version of the document and introduce comments to the clean version, without viewing the comments of other users. The comments made by a viewer, when displayed to another user, may be marked differently than those made by other users with higher authority levels. Additionally, the viewer 116 may be allowed to communicate with the other users who are simultaneously viewing the document over an instant messaging application. In some cases, the editor 108 and/or reviewer 112 sets these permissions regarding the level of access for the viewer 116.

Only one user of each user type is shown in FIG. 1A to avoid complicating the drawing; however the system 100 can also support multiple users with the same user type. When there are multiple reviewers, a reviewer 112 may view suggested edits and comments made by other reviewers 112. In this way, by allowing for efficient collaboration across a set of users proposing changes to a document, the system 100 offers significant advantages over a system in which reviewers independently propose changes to a document. Thus, when an editor 108 views the document, the editor 108 may view a live stream of collaborative updates made by multiple reviewers 112 at the same time, significantly reducing the amount of time to develop the document.

In this case, each user may be assigned a unique color, such that the changes in the markup version 105 of the document are color-coded by the user who made the changes. In addition, changes made by editors 108 may be marked differently on the markup version of the document from changes made by reviewers. Further, if a document has more than one editor 108, any editor 108 may accept or reject any suggested edit or delete any comment made by a reviewer. An editor 108 may, at once, accept or reject all suggested edits made by a particular reviewer 112 or editor 108. If a document has more than one viewer 116, in some embodiments, the viewers 116 may comment on the document and may also view comments made by other users (or may only view comments made by other viewers).

In some embodiments, any member of the public has a user type of viewer 116 by default. In other embodiments, only users approved by a reviewer 112 and/or an editor 108 have viewer status.

FIG. 1B is an example data structure 119 stored on electronic database 103 that includes a document access control list, according to an illustrative embodiment. The document access control list includes a list of users who have access to a version of the master document 106 and their corresponding user types. In this case, multiple users have the same user type. In particular, there are four reviewers (users A-C and G), two editors (users D and E), and two viewers (users F and H), all of whom may simultaneously interact with the master document 106. In addition to user id and user type, the document access control list may include other fields such as read permissions, write permissions, edit permissions, comment permissions, or any suitable combination thereof. In some embodiments, an access control list exists for each version of the document. For example, there may be an access control list for the markup version 105 and a separate access control list for the clean version 107.

FIG. 1C depicts two exemplary data structures 120 and 121 stored on electronic database 103 that include metadata corresponding to suggested edits (data structure 120) and comments (data structure 121), according to an illustrative embodiment. The data structure 120 includes four records of suggested edits. Each record in the data structure 120 includes a “suggested edit id” field whose values include identification numbers for the edits. Each record in the data structure 120 further includes the user id of the user who suggested the edit, the time of the suggestion, whether the suggested edit was accepted or rejected, who accepted or rejected the edit, and the time of the acceptance or rejection. The data structure 120 indicates that suggested edits 687 and 1345 are pending, meaning they have not yet been accepted or rejected by an editor 108. Other fields with additional data such as the location in the document of the suggested edit, whether the suggested edit includes deleting or replacing existing objects in the document (and which objects to delete or replace), or whether the suggested edit includes adding objects, may also be included.

In some embodiments, the data related to a suggested edit may be stored as a mutation of the document. For example, a mutation may include data indicating changes made by the edit such as the user id of the user who created the suggested edit, deletions, additions, location of the edit, and a status of the edit, such as pending, rejected, or accepted.

The data structure 121 includes two records of comments. Each record in the data structure 121 includes a “comment id” field whose values include identification numbers for the comments. Each record in the data structure 121 further includes the user id of the user who made the comment, the time of the comment, whether the comment was deleted or not, who deleted the comment, and the time of deletion. The data structure 121 indicates that comment 154 has not been deleted. Other fields with additional data indicating, for example, the document section or location the comment refers to may also be included.

Data structures 119-121 and the markup and clean versions of the master document 106 may be stored on the same electronic database 103, or may be stored on different databases. In some embodiments, an original version of the master document 106 is stored on a database instead of, or in addition to the markup 105 and clean 107 versions of the document. For example, the combination of the original version and data structures 120-121 would be enough to generate both markup 105 and clean 107 versions of the document using an “on the fly” approach. In particular, these versions of the document may not be stored on a database. Instead, when a user accesses the document, a version specific to that user (based on the user's permission settings) may be generated. The rest of this disclosure refers to using markup 105 and clean versions 107 of the document, but it will be understood that other versions of the document may also be stored, updated, and displayed.

In addition to the data stored in example data structures 119-121, the review manager 102 may also store additional data. For example, data indicative of how all users interact with the document may be stored such as what portions of the document are most viewed or read. Other data related to the users accessing the document may also be stored such as which browser applications or operating systems are used by each user to access the document, the user locations, which users return to view the document for a second or third time, or any other suitable data.

In some embodiments, recommendation data are also stored. A recommender is a user who recommends the document to others by sending the document's information in an email, posting in an online forum or on a social networking platform, or any other suitable way to recommend a document. The document's information may be specific to the user recommending the document, such as a unique URL for each recommender. Then, the number of new users who access or request access to the document through the unique URL may be stored in a data structure.

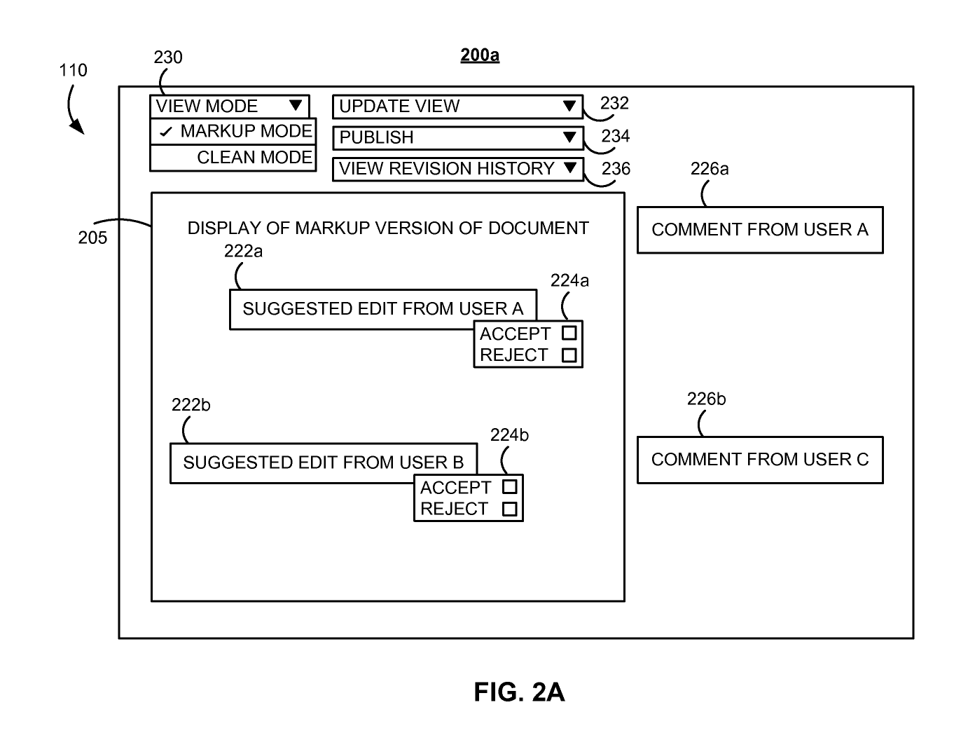

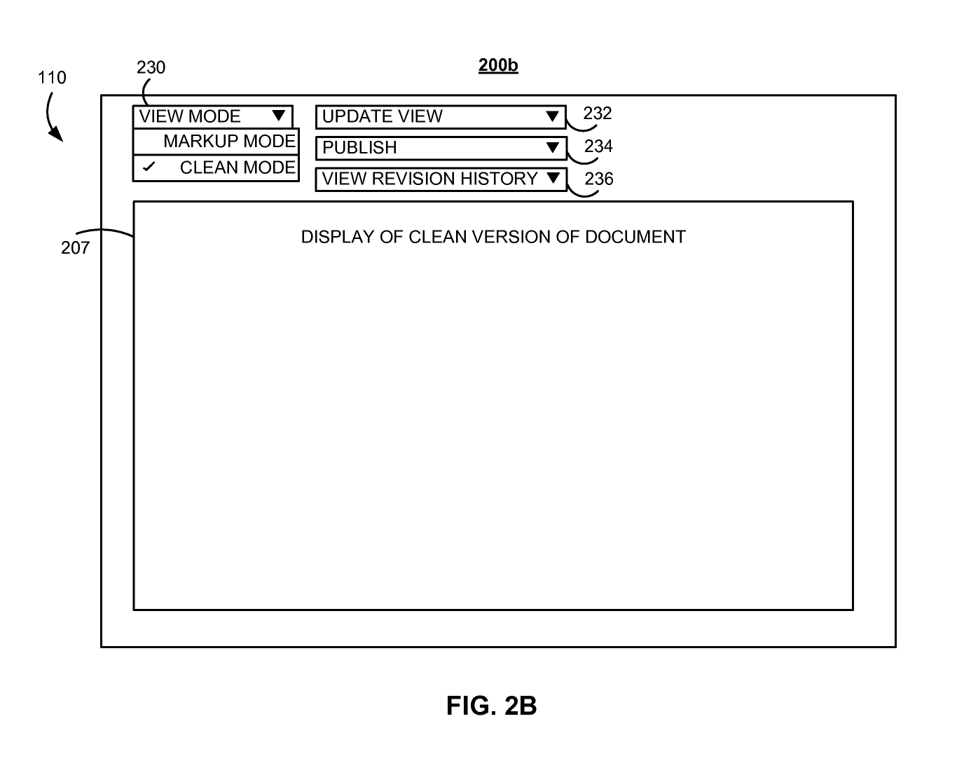

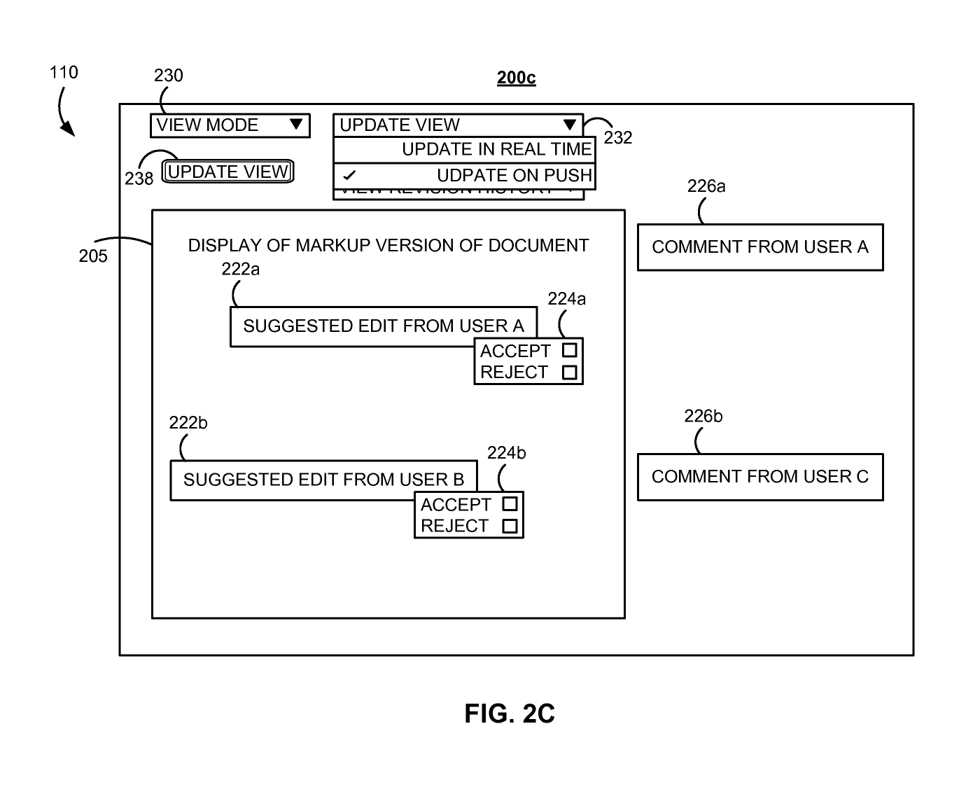

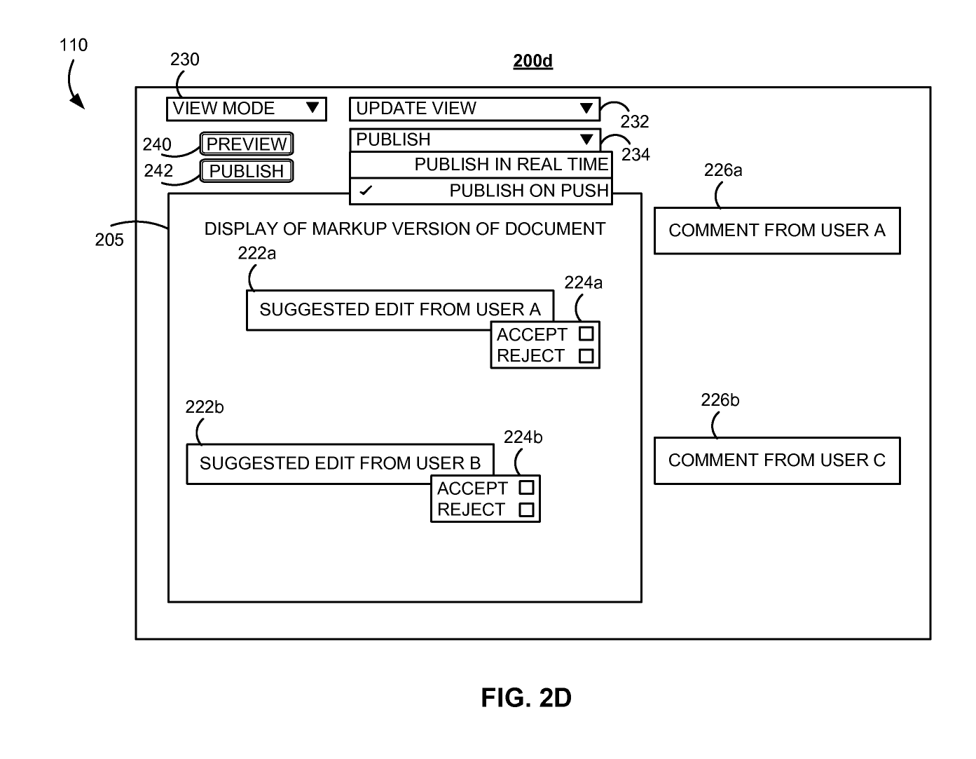

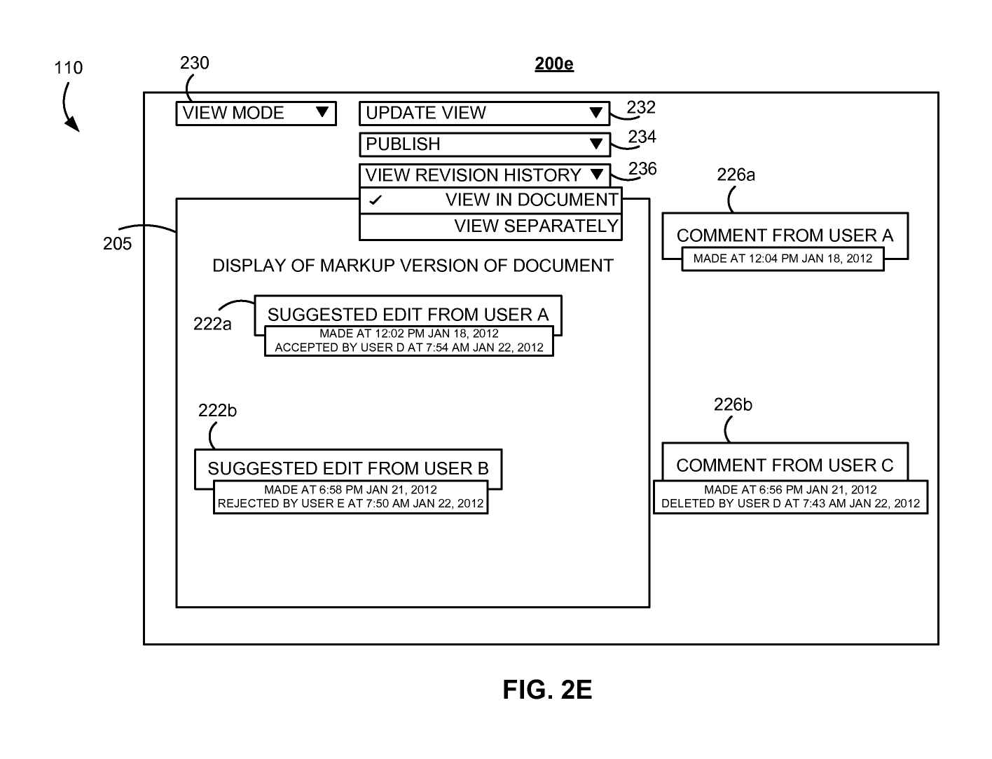

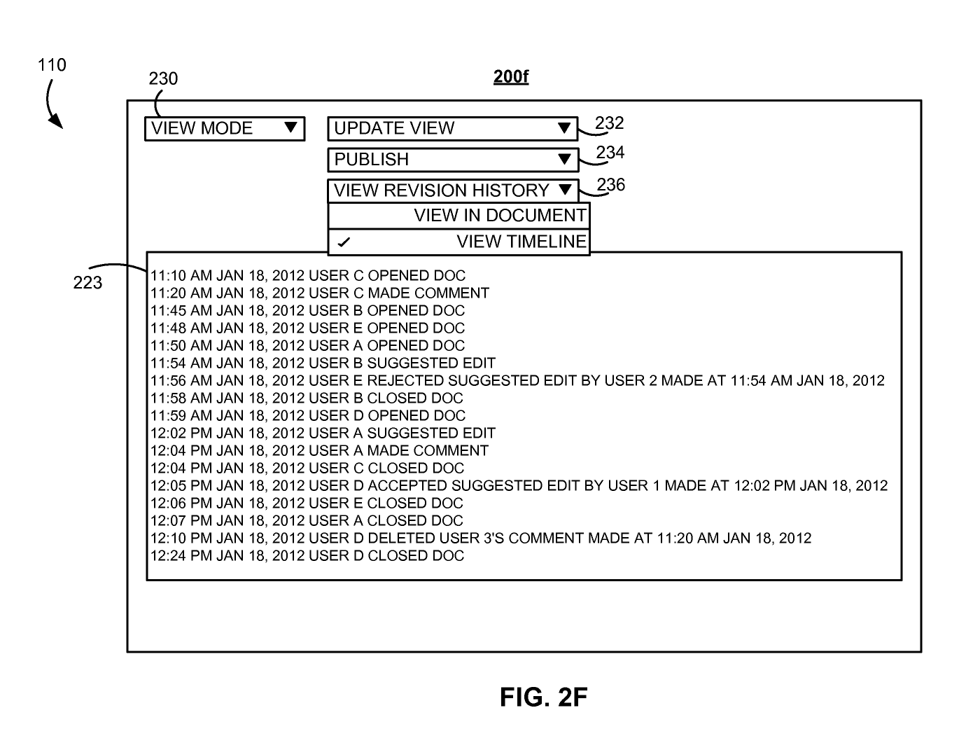

FIGS. 2A-2F are diagrams 200a-200f of exemplary displays of a user interface for an editor 108 interacting with the master document 106, according to an illustrative embodiment. Diagrams 200a-200f include various options that the editor 108 sets, including view mode 230, update view 232, publish 234, and view revision history 236.

In diagram 200a, the markup mode is selected for view mode 230, resulting in the display of the markup version 105 of the document. The markup version of the document includes suggested edits 222a and 222b and comments 226a and 226b from various users, who may be reviewers or other editors. Editor 108 can select to accept or reject each suggested edit 222a or 222b by selecting the appropriate option in box 224a and 224b. Editor 108 can also select to delete comments 226a and/or 226b.

In diagram 200b, the clean mode is selected for view mode 230, resulting in the display of the clean version 107 of the document. In contrast to the markup version 105, the clean version of the document does not display any suggested edits or comments, and only contains edits approved by an editor 108. In some embodiments, the clean version 107 is opened by default to the editor 108, who can then switch to the markup version 105.

In diagram 200c, the “update on push” option is selected under the update view option 232. When editor 108 selects this option, the editor's view of the document is updated only when the editor 108 presses the update view button 238. In this case, it may be desirable for the editor 108 to view a static version of the document when making decisions regarding the document. For example, the editor 108 may want to avoid distractions that may arise from viewing a live updated version of the document, in which suggested edits or comments from other users appear in real time. Alternatively, the editor 108 may select the option to “update in real time” under the update view option 232. This option is preferable if the editor 108 wishes to view an up-to-date version of the document.

In some embodiments, the “update on push” option is selected, such that the view of the document is static. However, the editor 108 may wish to be notified when an update to the document occurs without viewing the live updated version of the document. In this case, when the “update on push” option is selected such that a static markup version is displayed, the editor may select an option in which notifications appear on the editor interface 110 when an update to the markup version is made. The notification may simply be an alert on the editor interface 110 indicating that the markup version has been updated, or the notification may include information indicative of the type of update that has occurred. For example, the notification may point to a location in the current view of the document where the update has occurred and/or may indicate that some objects (e.g., text) in the document have been deleted, replaced, or added.

Furthermore, in some embodiments, notification that an update to the document has been made is sent to the editor 108 over email, text message, instant message, or any other suitable mode of notification. For example, the editor 108 may receive an email once in a time period (i.e., once a day, a week, two weeks, or any suitable time period) when comments or suggested edits are made by other users. In particular, the email may include all the comments made since the last notification, and a link may be provided in the email, such that the editor 108 may easily access the portion of the markup version of the document containing the comment in the notification.

In diagram 200d, the “publish on push” option is selected under the publish option 234. When this option is selected, the editor's changes to the document (e.g., any accepted or rejected edits, deleted comments, or direct edits made by the editor) are only published to any viewers of the mark-up and clean versions of the document when the publish button 242 is pressed. In addition, the editor may preview the same versions of the document before publishing by pressing the preview button 240. This option may be preferable if the editor 108 wishes to publish multiple changes to the document at once. For example, the editor 108 may make multiple inter-related changes to the document and does not want other users to view one change without viewing another change. Alternatively, the editor 108 may select the option to “publish in real time” under the publish option 234. In this case, the preview and publish buttons 240 and 242 are not shown or are otherwise not selectable on the editor interface 110. This option is preferable if the editor 108 wishes to publish his/her changes to the document to other users in real-time.

In diagram 200e, the “view in document” option is selected under the view revision history option 236. In contrast to the update view option 232 and the publish option 234, neither option in the view revision history option 236 needs to be selected at a given time. When the “view in document” option is selected, data corresponding to each suggested edit 222a and 222b and each comment 226a and 226b is displayed. In diagram 200e, this data includes the time and date each suggested edit or comment was made. For suggested edits, the data further includes a user id of the user (e.g., the editor 108) who accepted or rejected the suggested edit, and when the acceptance or rejection was made. For comments, the data further includes a user id of the user (e.g., the editor 108) who deleted a deleted comment and when the deletion occurred.

Diagram 200e includes all the same functionality as included in diagrams 200a, 200c, and 200d. In particular, the editor 108 can accept or reject suggested edits or delete comments while viewing the revision history in the document. Viewing the revision history also enables an editor 108 to undo any previous action performed by the same or another editor. For example, an editor may accept a suggested edit that was previously rejected by another editor, or reject an edit that was previously accepted by another editor.

In diagram 200f, the “view timeline” option is selected under the view revision history option 236. When this option is selected, data indicative of the time and date when each user opened the document, made a comment or a suggested edit, accepted or rejected a suggested edit, deleted a comment, or closed the document, are displayed in timeline 223. The revision history may also include information indicative of the edits and times when an editor published a set of changes (e.g., when the “publish on push” option is selected in diagram 200d and the editor presses the publish button 242).

Furthermore, if the editor 108 selects a location in the timeline 223 corresponding to a particular time, a previous version of the document corresponding to the updated document at that time may be displayed, and/or the previous version of the document may be selected as the clean version 107 or another version of the document.

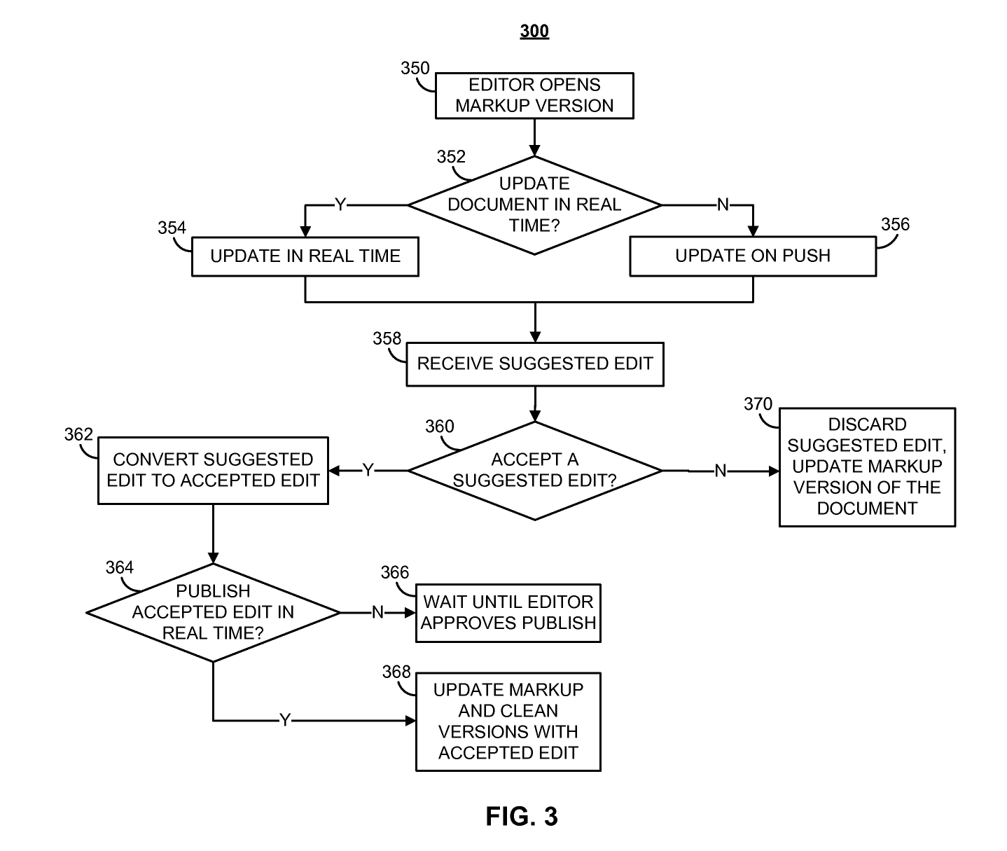

FIG. 3 is a flowchart 300 of a method used by the review manager 102 to manage updates to the markup and clean versions of the document, according to an illustrative embodiment. The method includes the steps of an editor 108 opening the markup version 105 of the document (step 350) and determining whether the editor wishes to update the document in real time (decision block 352). If so, the editor interface 110 operates in a mode in which the document is updated in real time (step 354), and otherwise, the editor interface 110 operates in an “update on push” mode (step 356). A suggested edit is received (step 358), and the editor is prompted whether to accept the suggested edit (decision block 360). If the suggested edit is not accepted, the suggested edit is discarded, and the markup version 105 is updated accordingly (step 370). If the suggested edit is accepted, the suggested edit is converted to an accepted edit (step 362), and the revision manager 102 determines whether to publish the accepted edit immediately (decision block 364). If so, the markup and clean versions of the document are updated with the accepted edit (step 368). Otherwise, the versions of the document are not updated until the editor approves the publishing of the accepted edit (step 366).

At step 350, the editor 108 opens the markup version 105 of the document on the editor interface 110. The editor interface 110 may include a web browser, and the editor 108 may be prompted to provide credentials (such as a user id and a password) before obtaining access to the markup version 105 of the document.

At decision block 352, the editor interface 110 determines whether the view of the document should be updated in real time. The editor 108 may be prompted with this option prior to or upon opening the document and may be required to select a view mode (update in real-time versus update on push) before the document is displayed. Alternatively, a default selection may be made such that the default view upon opening the document is in either mode. The default selection may be based on the mode last used by the editor 108 when accessing the document. When a mode has been selected (by the editor 108 or selected by default), the markup version of the document is then either updated in real time (step 354) or updated on push (step 356).

At step 358, a suggested edit from a reviewer or an editor is received by the review manager 102, and the markup version of the document is updated with the suggested edit. The views of the markup version 105 of the document at all user interfaces that are viewing the markup version 105 (i.e., corresponding to editors and reviewers) are then updated with the suggested edit (either in real time or upon push). When the view of the markup version of the document at the editor interface 110 is updated with the suggested edit, the editor interface 110 prompts the editor 108 with an option to accept or reject the suggested edit, such as in boxes 224a and 224b in FIG. 2A.

If the editor 108 selects to reject the suggested edit, the method proceeds to step 370, in which the review manager 102 discards the suggested edit and updates the markup version 105 of the document to reflect the rejection of the suggested edit. This may include showing the suggested edit in strikethrough font, or the suggested edit may disappear altogether from the markup version of the document. The views of the markup version 105 of the document at other user interfaces (such as those corresponding to other editors and reviewers) are also accordingly updated.

If the editor 108 selects to accept the suggested edit, the method proceeds to step 362, in which the review manager 102 converts the suggested edit to an accepted edit. At decision block 364, the review manager then determines whether to publish the accepted edit in real time, depending on whether the editor interface 110 is operating in “publish in real time” or “publish on push” modes (option 234 in FIG. 2D). If the editor interface 110 operates in “publish in real time” mode, then the review manager 102 updates both markup and clean version of the document with the accepted edit at step 368. Otherwise, the review manager 102 updates the document only when the editor approves publishing the edit at step 366 (i.e., by pressing the publish button 242 in FIG. 2D).

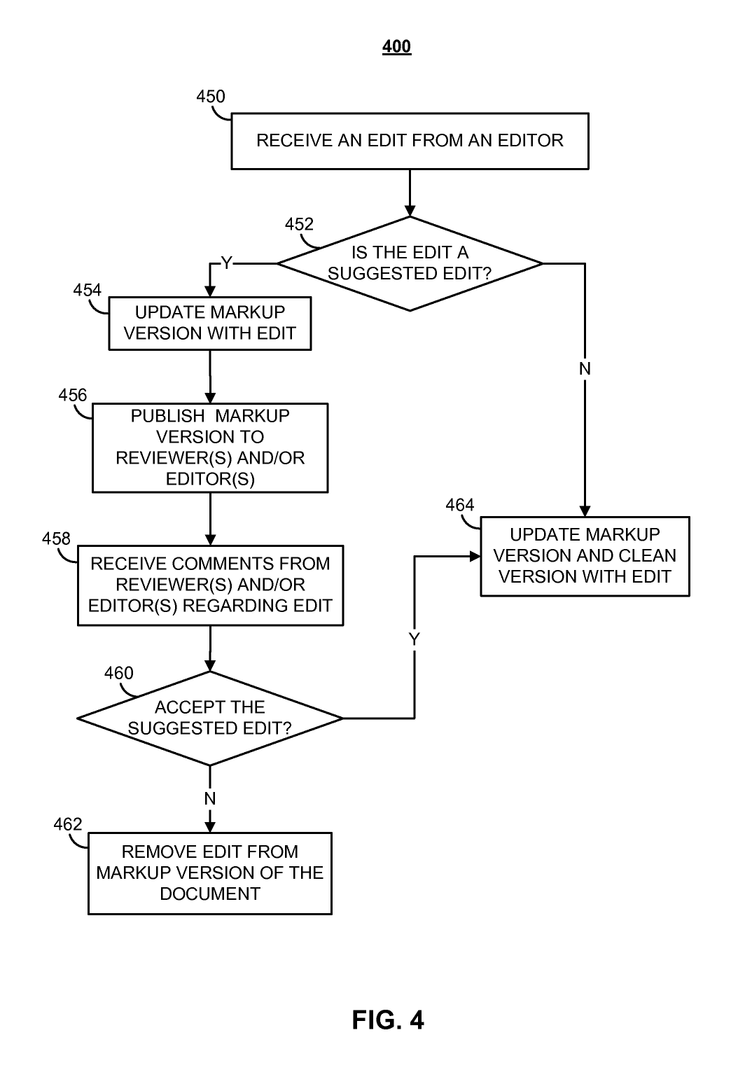

FIG. 4 is a flowchart 400 of a method used by the review manager 102 to manage updates to the markup and clean versions of the document, according to an illustrative embodiment. The method includes the steps of receiving an edit from an editor (step 450) and determining whether the received edit is a suggested edit (decision block 452). If not, the markup version 105 and the clean version 107 of the document are updated with the received edit (step 464). Otherwise, the markup version 105 is updated with the suggested edit (step 454), the updated markup version is published to any reviewer or editor who are viewing the markup version (step 456), and comments are received from the users regarding the suggested edit (step 458). At decision block 460, the review manager 102 determines whether the suggested edit is accepted or rejected. If accepted, both markup and clean versions of the document are updated with the edit. Otherwise, the edit is removed from the markup version 105.

At step 450, the review manager 102 receives an edit from an editor 108. At decision block 452, the review manager 102 determines whether the received edit is a suggested edit. As described in relation to FIG. 1A, the editor 108 may select to have an edit treated as a suggested edit or as an accepted edit. If the review manager 102 determines that the received edit is to be treated as an accepted edit, the method proceeds to step 464, in which the markup and clean versions of the document are both updated with the received edit. In both versions, the document is updated with the received edit as if the edit was already accepted by an editor 108 (i.e., edit appears without markup or redline).

Alternatively, if the received edit is to be treated as a suggested edit, the review manager 102 treats the edit as if it was received from a reviewer. In this case, the method proceeds to step 454, in which the markup version 105 of the document is updated with the received edit as a suggested edit (i.e., the received edit is added to the markup version in redline mode). At step 456, the view of the markup version 105 is updated at the user interface for reviewers and editors, and at step 458, these users make comments regarding the edit. At decision block 460, an editor accepts or rejects the edit. The editor who accepts or rejects the edit may or may not be the same editor who made the suggested edit, and the decision to accept or reject the edit may be based on the received comments in step 458. If the edit is accepted, the method proceeds to step 464, where both markup and clean versions of the document are updated with the accepted edit. Alternatively, at step 462, the edit is removed from the markup version of the document, or is otherwise marked to reflect that it has been rejected.

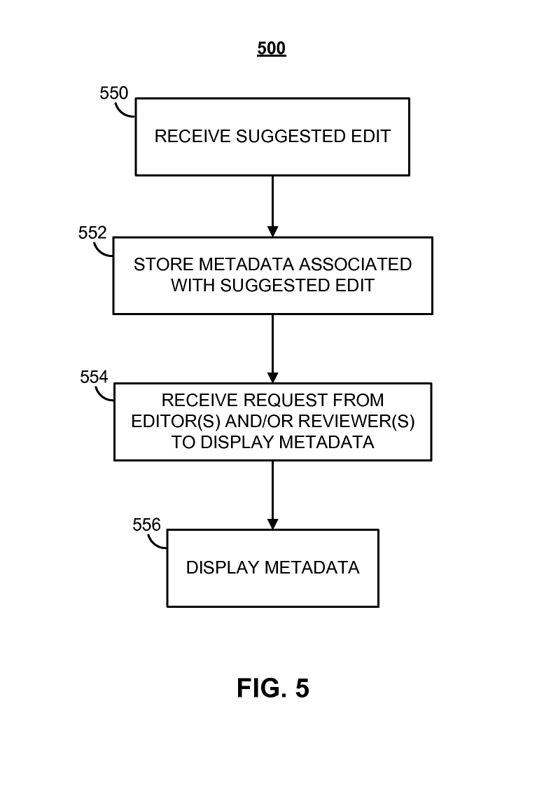

FIG. 5 is a flowchart 500 of a method used by the review manager 102 to store and display metadata corresponding to edits received from users of the document, according to an illustrative embodiment. The method includes the steps of receiving a suggested edit (step 550), storing metadata associated with the suggested edit (step 552), receiving a request from a user to display the metadata (step 554), and displaying the metadata (step 556).

At step 550, the review manager 102 receives a suggested edit from a user device (e.g., corresponding to an editor 108 or a reviewer 112). At step 552, the review manager 102 stores metadata associated with the suggested edit. For example, the metadata may correspond to revision history data stored in the data structure 120 of FIG. 1C may be stored at step 552. This data may include a suggested edit id, which may be a number corresponding to the suggested edit, the user id of the user who suggested the edit, and the time of the suggested edit. In addition, if the suggested edit has been accepted or rejected by an editor 108, the data may further include the user id of the user who accepted or rejected the edit and the time of the acceptance or rejection. Furthermore, the data may also include other data corresponding to the suggested edit, such as the location in the document of the suggested edit, any objects in the document that the suggested edit replaces or deletes, and any additional objects included in the suggested edit. The review manager 102 may store this metadata in a data structure such as data structure 120 or any other suitable data structure on a database such as electronic database 103 or any other suitable database.

At step 554, the review manager 102 receives a request from an editor 108 and/or a reviewer 112 to display the metadata. This request from a user may correspond to an editor 108 selecting an option in the view revision history option 236 in FIGS. 2E and 2F. At step 556, the review manager 102 then displays the metadata to the user who sent the request. Exemplary views of the display of the metadata are shown in FIGS. 2E and 2F.

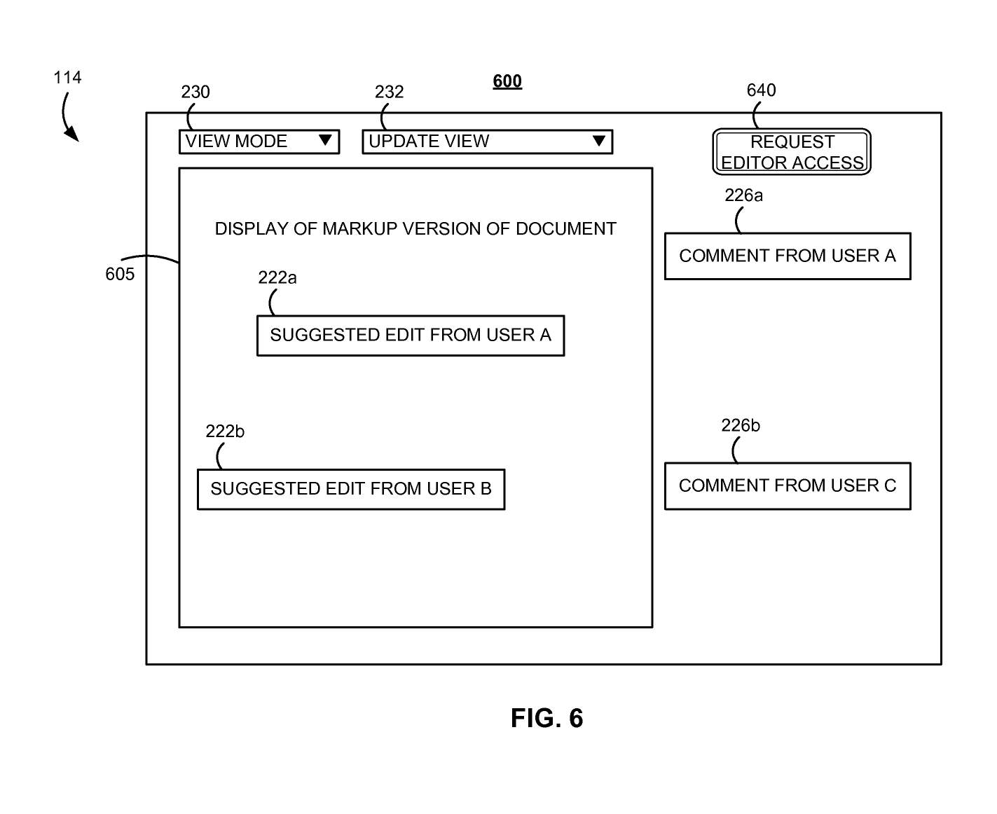

FIG. 6 is a diagram 600 of an exemplary display of a reviewer interface 114 for a reviewer 112 interacting with the master document 106, according to an illustrative embodiment. Diagram 600 is identical to diagram 200a with the exception that the publish option 234 and the view revision history 236 are not shown in diagram 600. Diagram 600 also includes an additional feature: a “request editor access” button 640. When the reviewer 112 selects the button 640, a request is sent to one or more editors to either allow or deny the reviewer 112 editor access to the document.

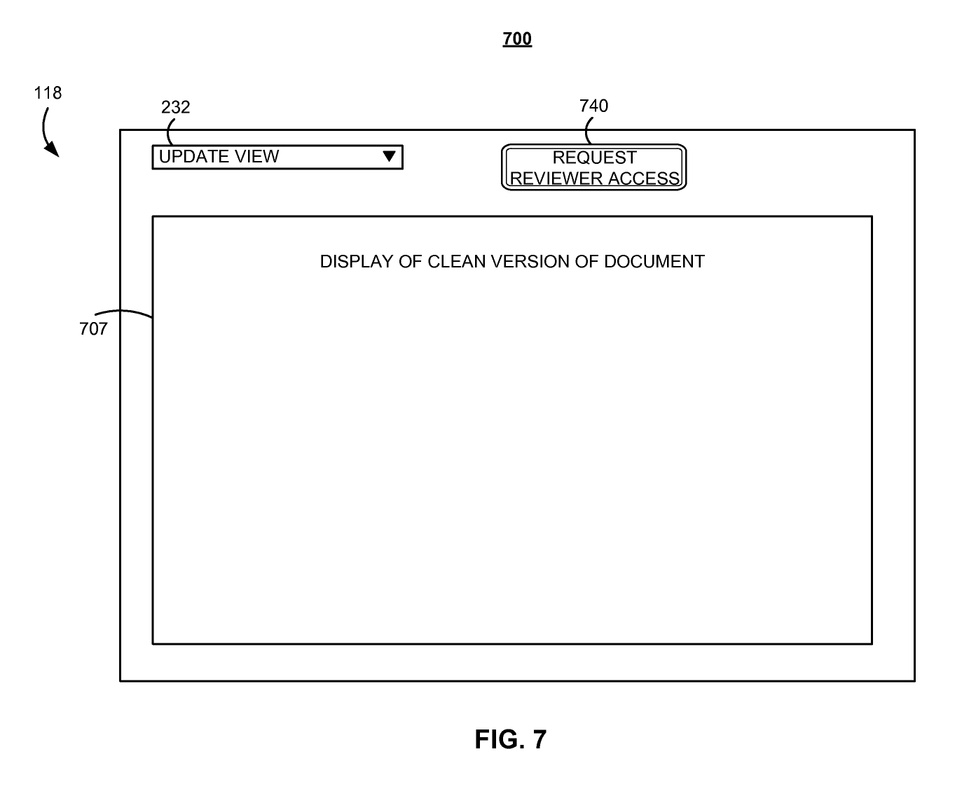

FIG. 7 is a diagram 700 of an exemplary display of a viewer interface 118 for a viewer 116 interacting with the master document 106, according to an illustrative embodiment. Diagram 700 is identical to diagram 200b with the exception that the view mode option 230, the publish option 234, and the view revision history 236 are not shown in diagram 700. Diagram 700 also includes an additional feature: a “request reviewer access” button 740. When the viewer 116 selects the button 740, a request is sent to an editor and/or a reviewer to either allow or deny the viewer 116 reviewer access to the document.

In addition, the viewer 116 may request that notifications appear on the viewer interface 118 when an update to the clean version 707 is made. The notification may simply be an alert on the viewer interface 118 indicating that the clean version has been updated, or the notification may include information indicative of the type of update that has occurred. For example, the notification may point to a location in the current view of the document where the update has occurred and/or may indicate that some objects (e.g., text) in the document have been deleted, replaced, or added. The viewer may select a button placed on or near the notification to refresh the view of the clean version 707 of the document.

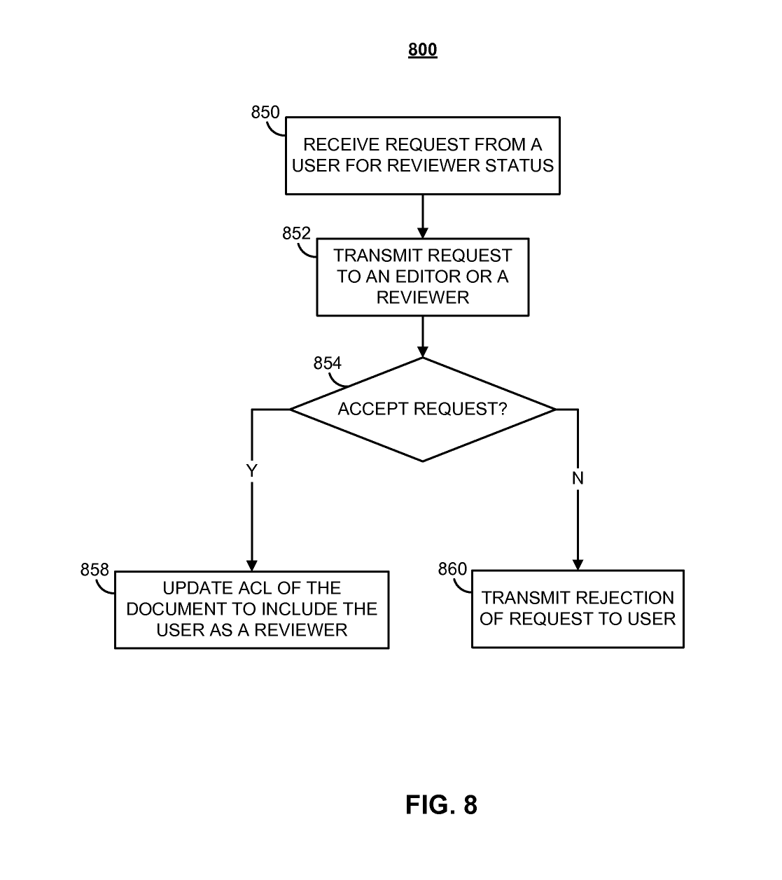

FIG. 8 is a flowchart 800 of a method used by the review manager 102 to handle a request for a change in user type from a user, according to an illustrative embodiment. The method includes the steps of receiving a request from a user for reviewer status (step 850), transmitting the request to an editor or a reviewer (step 852), and determining whether the request is accepted (decision block 854). If the request is denied, the review manager 102 transmits a rejection of the request to the user (step 860). Otherwise, the access control list of the document is updated to reflect that the user is a reviewer (step 858).

The method in flowchart 800 may be similarly used for a reviewer requesting editor status or for a viewer requesting editor status. In addition, a user who is not on the document access control list 119 may also request viewer, reviewer, or editor status using a similar method.

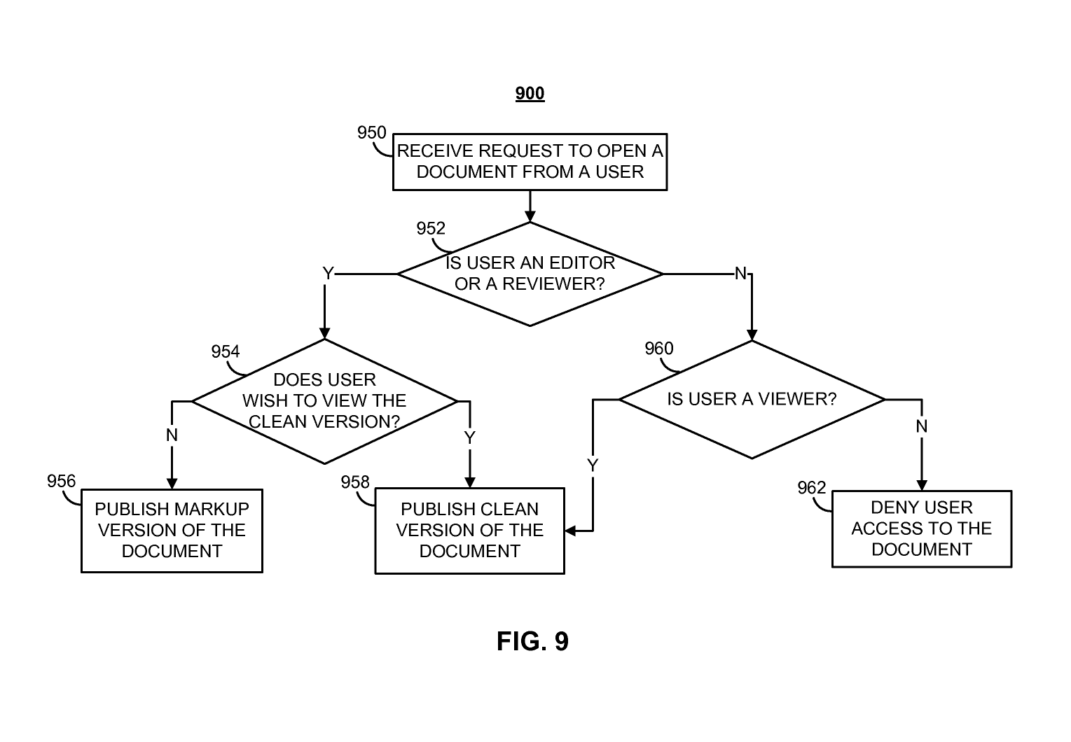

FIG. 9 is a flowchart 900 of a method used by the review manager 102 to handle a request to open a document from a user, according to an illustrative embodiment. The method includes the steps of receiving a request from a user to open a document (step 950), determining if the user is an editor or a reviewer (decision block 952), if so, determining whether the user wishes to view the clean version (decision block 954), and publishing the desired version (steps 956 and 958). Alternatively, the review manager 102 determines whether the user is a viewer (decision block 960), and if so, publishes the clean version of the document (step 958). Otherwise, the review manager 102 denies the user access to the document (step 962).

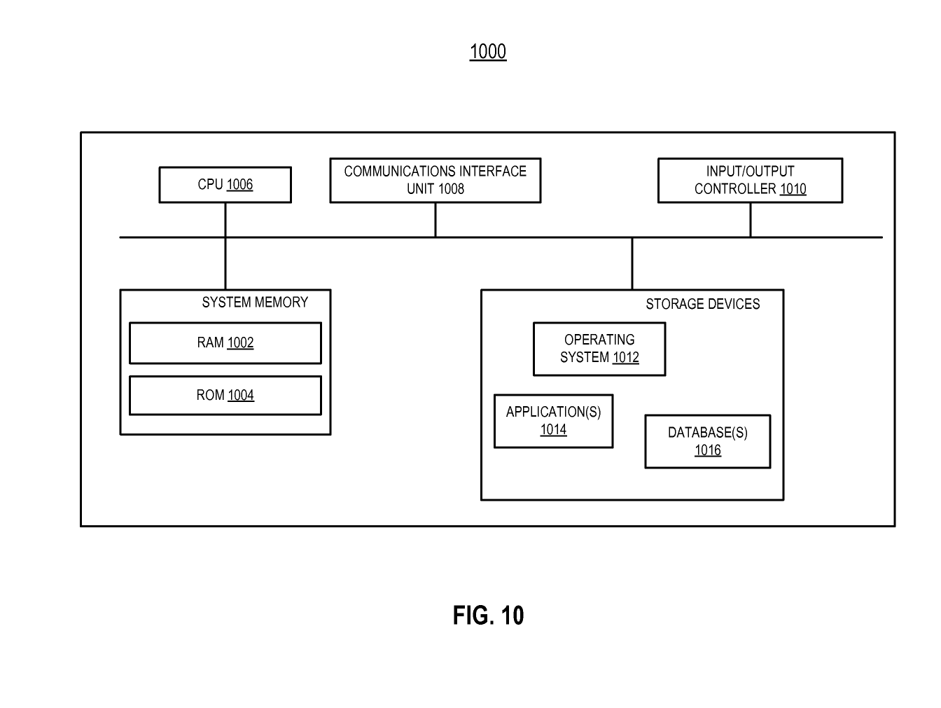

FIG. 10 is a block diagram of a computing device, such as any of the components of the system of FIG. 1A, for performing any of the processes described herein. Each of the components of these systems may be implemented on one or more computing devices 1000. In certain aspects, a plurality of the components of these systems may be included within one computing device 1000. In certain implementations, a component and a storage device may be implemented across several computing devices 1000.

The computing device 1000 comprises at least one communications interface unit, an input/output controller 1010, system memory, and one or more data storage devices. The system memory includes at least one random access memory (RAM 1002) and at least one read-only memory (ROM 1004). All of these elements are in communication with a central processing unit (CPU 1006) to facilitate the operation of the computing device 1000. The computing device 1000 may be configured in many different ways. For example, the computing device 1000 may be a conventional standalone computer or alternatively, the functions of computing device 1000 may be distributed across multiple computer systems and architectures. In FIG. 10, the computing device 1000 is linked, via network or local network, to other servers or systems.

The computing device 1000 may be configured in a distributed architecture, wherein databases and processors are housed in separate units or locations. Some units perform primary processing functions and contain at a minimum a general controller or a processor and a system memory. In distributed architecture implementations, each of these units may be attached via the communications interface unit 1008 to a communications hub or port (not shown) that serves as a primary communication link with other servers, client or user computers and other related devices. The communications hub or port may have minimal processing capability itself, serving primarily as a communications router. A variety of communications protocols may be part of the system, including, but not limited to: Ethernet, SAP, SAS™, ATP, BLUETOOTH™, GSM and TCP/IP.

The CPU 1006 comprises a processor, such as one or more conventional microprocessors and one or more supplementary co-processors such as math co-processors for offloading workload from the CPU 1006. The CPU 1006 is in communication with the communications interface unit 1008 and the input/output controller 1010, through which the CPU 1006 communicates with other devices such as other servers, user terminals, or devices. The communications interface unit 1008 and the input/output controller 1010 may include multiple communication channels for simultaneous communication with, for example, other processors, servers or client terminals.

The CPU 1006 is also in communication with the data storage device. The data storage device may comprise an appropriate combination of magnetic, optical or semiconductor memory, and may include, for example, RAM 1002, ROM 1004, flash drive, an optical disc such as a compact disc or a hard disk or drive. The CPU 1006 and the data storage device each may be, for example, located entirely within a single computer or other computing device; or connected to each other by a communication medium, such as a USB port, serial port cable, a coaxial cable, an Ethernet cable, a telephone line, a radio frequency transceiver or other similar wireless or wired medium or combination of the foregoing. For example, the CPU 1006 may be connected to the data storage device via the communications interface unit 1008. The CPU 1006 may be configured to perform one or more particular processing functions.

The data storage device may store, for example, (i) an operating system 1012 for the computing device 1000; (ii) one or more applications 1014 (e.g., computer program code or a computer program product) adapted to direct the CPU 1006 in accordance with the systems and methods described here, and particularly in accordance with the processes described in detail with regard to the CPU 1006; or (iii) database(s) 1016 adapted to store information that may be utilized to store information required by the program.

The operating system 1012 and applications 1014 may be stored, for example, in a compressed, an uncompiled and an encrypted format, and may include computer program code. The instructions of the program may be read into a main memory of the processor from a computer-readable medium other than the data storage device, such as from the ROM 1004 or from the RAM 1002. While execution of sequences of instructions in the program causes the CPU 1006 to perform the process steps described herein, hard-wired circuitry may be used in place of, or in combination with, software instructions for implementation of the processes of the present disclosure. Thus, the systems and methods described are not limited to any specific combination of hardware and software.

Suitable computer program code may be provided for performing one or more functions in relation to integrating collaboratively proposed changes and publishing as described herein. The program also may include program elements such as an operating system 1012, a database management system and “device drivers” that allow the processor to interface with computer peripheral devices (e.g., a video display, a keyboard, a computer mouse, etc.) via the input/output controller 1010.

The term “computer-readable medium” as used herein refers to any non-transitory medium that provides or participates in providing instructions to the processor of the computing device 1000 (or any other processor of a device described herein) for execution. Such a medium may take many forms, including but not limited to, non-volatile media and volatile media. Non-volatile media include, for example, optical, magnetic, or opto-magnetic disks, or integrated circuit memory, such as flash memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other non-transitory medium from which a computer can read.

Various forms of computer readable media may be involved in carrying one or more sequences of one or more instructions to the CPU 1006 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device 1000 (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

While various embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments described herein may be employed in practicing the invention. It is intended that the following claims define the scope of the invention and that methods and structures within the scope of these claims and their equivalents be covered thereby.

1. A non-transitory computer readable medium storing computer executable instructions, which, when executed by a processor, cause the processor to carry out a method for integrating collaboratively proposed changes from a plurality of users and publishing an electronic document, comprising:
receiving a first suggested edit to the electronic document from a reviewer;
updating a markup version of the electronic document to reflect the first suggested edit;
receiving an acceptance or a rejection of the first suggested edit from an editor;
in response to receiving an acceptance of the first suggested edit from the editor,
converting the first suggested edit in the updated markup version to an accepted edit, yielding a second updated markup version;
updating a clean version of the electronic document with the accepted edit; and
publishing the updated clean version.

2. The non-transitory computer readable medium of claim 1, wherein the reviewer and the editor simultaneously access the electronic document.

3. The non-transitory computer readable medium of claim 1, wherein the reviewer is a user with a first authorization level and the editor is a user with a second authorization level greater than the first authorization level.

4. The non-transitory computer readable medium of claim 1, wherein the method further comprises:
receiving a comment on the electronic document from the reviewer;
updating the markup version to reflect the comment.

5. The non-transitory computer readable medium of claim 1, wherein the method further comprises:
receiving an edit from the editor;
updating the markup version with the edit; and
updating the clean version with the edit.

6. The non-transitory computer readable medium of claim 1, wherein the method further comprises:
receiving a request from the reviewer and/or the editor to view the clean version of the electronic document; and
publishing the clean version.

7. The non-transitory computer readable medium of claim 1, wherein a viewer is a user authorized to view the clean version and unauthorized to view the markup version.

8. The non-transitory computer readable medium of claim 7, wherein the method further comprises:
receiving a request from the viewer to become a reviewer for the electronic document;
transmitting the request to the editor;
receiving an acceptance or a rejection of the request from the editor;
in response to receiving an acceptance of the request,
converting the viewer to a second reviewer;
granting access to the markup version of the electronic document to the second reviewer;
receiving a second suggested edit from the second reviewer;
in response to receiving a rejection of the request,
notifying the viewer of the rejection of the request.

9. The non-transitory computer readable medium of claim 1, wherein the method further comprises:
receiving a request from the reviewer to become an editor for the electronic document;
transmitting the request to the editor;
receiving an acceptance or a rejection of the request from the editor;
in response to receiving an acceptance of the request,
converting the reviewer to a second editor;
in response to receiving a rejection of the request,
notifying the reviewer of the rejection of the request.

10. The non-transitory computer readable medium of claim 1, wherein the method further comprises monitoring data corresponding to interactions with the electronic document by a user.

11. The non-transitory computer readable medium of claim 1, wherein the method further comprises storing and displaying metadata corresponding to a revision history of the electronic document to the editor.

12. The non-transitory computer readable medium of claim 1, wherein the method further comprises providing an updated version of the electronic document to a user when prompted by the user.

13. The non-transitory computer readable medium of claim 1, wherein the method further comprises notifying a user that the markup and/or clean versions of the electronic document have been updated.

14. A method for integrating collaboratively proposed changes from a plurality of users and publishing an electronic document, comprising:
receiving a first suggested edit to the electronic document from a reviewer;
updating a markup version of the electronic document to reflect the first suggested edit;
receiving an acceptance or a rejection of the first suggested edit from an editor;
in response to receiving an acceptance of the first suggested edit from the editor,
converting the first suggested edit in the updated markup version to an accepted edit, yielding a second updated markup version;
updating a clean version of the electronic document with the accepted edit; and
publishing the updated clean version.

15. The method of claim 14, wherein the reviewer and the editor simultaneously access the electronic document.

16. The method of claim 14, wherein the reviewer is a user with a first authorization level and the editor is a user with a second authorization level greater than the first authorization level.

17. The method of claim 14, further comprising:
receiving a comment on the electronic document from the reviewer;
updating the markup version to reflect the comment.

18. The method of claim 14, further comprising:
receiving an edit from the editor;
updating the markup version with the edit; and
updating the clean version with the edit.

19. The method of claim 14, further comprising:
receiving a request from the reviewer and/or the editor to view the clean version of the electronic document; and
publishing the clean version.

20. The method of claim 14, wherein a viewer is a user authorized to view the clean version and unauthorized to view the markup version.

21. The method of claim 20, further comprising:
receiving a request from the viewer to become a reviewer for the electronic document;
transmitting the request to the editor;
receiving an acceptance or a rejection of the request from the editor;
in response to receiving an acceptance of the request,
converting the viewer to a second reviewer;
granting access to the markup version of the electronic document to the second reviewer;
receiving a second suggested edit from the second reviewer;
in response to receiving a rejection of the request,
notifying the viewer of the rejection of the request.

22. The method of claim 14, further comprising:
receiving a request from the reviewer to become an editor for the electronic document;
transmitting the request to the editor;
receiving an acceptance or a rejection of the request from the editor;
in response to receiving an acceptance of the request,
converting the reviewer to a second editor;
in response to receiving a rejection of the request,
notifying the reviewer of the rejection of the request.

23. The method of claim 14, further comprising monitoring data corresponding to interactions with the electronic document by a user.

24. The method of claim 14, further comprising storing and displaying metadata corresponding to a revision history of the electronic document to the editor.

25. The method of claim 14, further comprising providing an updated version of the electronic document to a user when prompted by the user.

26. The method of claim 14, further comprising notifying a user that the markup and/or clean versions of the electronic document have been updated.

27. A system for integrating collaboratively proposed changes from a plurality of users and publishing an electronic document, comprising a processor configured to:
receive a first suggested edit to the electronic document from a reviewer;
update a markup version of the electronic document to reflect the first suggested edit;
receive an acceptance or a rejection of the first suggested edit from an editor;
in response to receiving an acceptance of the first suggested edit from the editor,
convert the first suggested edit in the updated markup version to an accepted edit, yielding a second updated markup version;
update a clean version of the electronic document with the accepted edit; and
publish the updated clean version.

28. The system of claim 27, wherein the reviewer and the editor simultaneously access the electronic document.

29. The system of claim 27, wherein the reviewer is a user with a first authorization level and the editor is a user with a second authorization level greater than the first authorization level.

30. The system of claim 27, wherein the processor is further configured to:
receive a comment on the electronic document from the reviewer;
update the markup version to reflect the comment.

31. The system of claim 27, wherein the processor is further configured to:
receive an edit from the editor;
update the markup version with the edit; and
update the clean version with the edit.

32. The system of claim 27, wherein the processor is further configured to:
receive a request from the reviewer and/or the editor to view the clean version of the electronic document; and
publish the clean version.

33. The system of claim 27, wherein a viewer is a user authorized to view the clean version and unauthorized to view the markup version.

34. The system of claim 33, wherein the processor is further configured to:
receive a request from the viewer to become a reviewer for the electronic document;
transmit the request to the editor;
receive an acceptance or a rejection of the request from the editor;
in response to receiving an acceptance of the request,
convert the viewer to a second reviewer;
grant access to the markup version of the electronic document to the second reviewer;
receive a second suggested edit from the second reviewer;
in response to receiving a rejection of the request,
notify the viewer of the rejection of the request.

35. The system of claim 27, wherein the processor is further configured to:
receive a request from the reviewer to become an editor for the electronic document;
transmit the request to the editor;
receive an acceptance or a rejection of the request from the editor;
in response to receiving an acceptance of the request,
convert the reviewer to a second editor;
in response to receiving a rejection of the request,
notify the reviewer of the rejection of the request.

36. The system of claim 27, wherein the processor is further configured to monitor data corresponding to interactions with the electronic document by a user.

37. The system of claim 27, wherein the processor is further configured to store and display metadata corresponding to a revision history of the electronic document to the editor.

38. The system of claim 27, wherein the processor is further configured to provide an updated version of the electronic document to a user when prompted by the user.

39. The system of claim 27, wherein the processor is further configured to notify a user that the markup and/or clean versions of the electronic document have been updated.
